(19) United States
(12) Patent Application Publication
(10) Pub. No.: US 2007/0080622 A1
(43) Pub. Date: Apr. 12, 2007

(54) Method for forming phosphor screen with metal back

(75) Inventors: Masaaki Inamura, Saitama-ken (JP); Hajime Tanaka, Gunma-ken (JP); Masayuki Yoshii, Saitama-ken (JP); Yasunori Gamo, Saitama-ken (JP); Takeo Ito, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku Tokyo (JP)

(21) Appl. No.: 10/580,158

(22) PCT Filed: Nov. 18, 2004
(86) PCT No.: PCT/JP04/17149

§ 371 Date: Dec. 20, 2006

(30) Foreign Application Priority Data
Nov. 21, 2003 (JP) 2003-392493

(51) Int. Cl. H01J 29/10

(52) U.S. Cl. 313/461

(57) ABSTRACT

Disclosed is a method for forming a metal back-attached phosphor screen, the method comprising the steps of: forming a phosphor layer (10) on an inner surface of a face plate (8); disposing a transfer film (1) in which at least a release agent layer (3), a smooth resin film (4) and an adhesive agent layer (5) are formed on a basefilm (2) onto the phosphor layer (10) pressing the transfer film (1) while applying heat by a transfer roller (7) to bond the transfer film (1), to thereby transfer the resin film; forming a metal film on the transferred resin film; and heating the face plate in which the metal film is formed.

### TECHNICAL FIELD

The present invention relates to a method for forming a metal back-attached phosphor screens and in more detail, relates to a method for forming the metal back-attached phosphor screen in a flat image display device such as a field emission display (FED).

### BACKGROUND ART

Conventionally, in a phosphor screen of an image display device such as a cathode-ray tube (CRT) and an FED, a structure of a metal back system in which a metal film such as aluminum (Al) is formed on an inner surface (surface opposite to a glass plate) of a phosphor layer is popularly used.

This metal back system is intended to send luminous energy to a front surface of a face plate more effectively by reflecting light emitted from a phosphor layer which is excited by an electron from an electron source, and to fulfill a role as an electrode by giving conductivity to the phosphor layer.

In forming a metal back layer, there is conventionally adopted a method (lacquer method) in which a thin film made of nitrocellulose or the like is formed on the phosphor layer by a spin method or the like, Al is vacuum-deposited thereon, and an organic material is removed by baking.

Further, as a convenient formation method of the metal back layer, there is proposed a method (transfer system) In which a metal deposited film is formed on a film coated with a release agent in advance and this metal film is transferred onto the phosphor layer by using an adhesive agent (see Patent Document 1, for example).

However, in the conventional lacquer method and the method for forming the metal back layer by the transfer system, it is difficult to secure a sufficient adhesiveness between the phosphor layer and the metal back layer. Accordingly, in the flat image display device which has a narrow gap space) between an electron emission source and the phosphor screen in particular, it is difficult to realize a favorable withstand voltage characteristic (high critical holding voltage).

There is proposed a method in which the metal film is formed by the transfer system and then the transferred metal film is further pressed in order to enhance the adhesiveness between the phosphor layer and the metal back layer, but even in this method it is difficult to form a metal back layer without a defect such as a crack or a pinhole and with a low light transmittance.

In order to for a metal back layer in which the light transmittance is kept low to reflect light efficiently, a thickness of the metal film is required to be large, but there is a drawback that increase in the film thickness leads to a high dead voltage (lower limit value of an electron beam accelerating voltage necessary for emission). Further, there is a problem that kinds of metals or ranges of film thicknesses which can be applied are limited.

Patent Document 1 JP-A 63-102139 (KOKAI) (page 2, pages 3-4)

### DISCLOSURE OF THE INVENTION

The present invention is made to solve the above problems and an object thereof is to provide a method for forming a metal back-attached phosphor screen in which an adhesiveness between a back-attached phosphor screen in which an adhesiveness between a phosphor layer and a metal back layer is favorable to lead to an excellent withstand voltage characteristic, and a light transmittance of the metal back layer is low to lead to a favorable reflectively, with a good yield.

A method for forming a metal back-attached phosphor screen of the present invention comprises forming a phosphor layer on an inner surface of a face plate, disposing a transfer film in which at least a release agent layer, a smooth resin film and an adhesive agent layer are formed on a base film onto the phosphor layer so that the resin film contacts the phosphor layer with the adhesive agent layer intervened therebetween, pressing the transfer film while applying heat by a transfer roller to bond the transfer film, and subsequently peeling off the base film, to thereby transfer the resin film, forming a metal film on the resin film transferred onto the phosphor layer, and heating the face plate in which the metal film is formed.

In the present invention, after the resin film having smoothness is transferred/formed onto the phosphor layer, the metal film is formed on this smooth resin film, and further, heating is performed, and hence the adhesiveness between the phosphor layer and the metal back layer is increased so that a withstand voltage characteristic, in particular a critical holding voltage, is enhanced Further, by forming the metal film on the resin film having smoothness, the resin film being formed on the phosphor layer, the metal back layer without a defect such as a crack or a pinhole can be formed with a good yield, so that the metal back-attached phosphor screen of an image display device with an excellent withstand voltage characteristic can be obtained.

### BRIEF DESCRIPTION OF DRAWINGS

FIG. 1 is a cross-sectional view showing a structure of a transfer film used in an embodiment of the present invention;

FIG. 2 is a drawing schematically showing a transfer process of a smooth resin film in the embodiment of the present invention; and

FIG. 3 is a cross-sectional view of an FED provided with a metal back-attached phosphor screen produced according to the embodiment of the present invention.

### BEST MODE FOR IMPLEMENTING THE INVENTION

Hereinafter, an embodiment according to the present invention will be described. It should be noted that the present invention is not limited to the following embodiment.

In the embodiment of the present inventions, first, after light absorption layers (light shielding layers) made of a black pigment in dots or stripes are formed on an inner surface of a face plate by a photolithography method for example, a slurry containing phosphors of respective colors of ZnS-base, Y₂O₃base, Y₂O₂S-base or the like is applied thereon and dried, patterning being performed using the photolithography method. Accordingly, patters of phosphor layers of three colors of red (R), green (G), and blue (B) are arranged between the patterns of the light absorption layer in a manner to be adjacent to each other to form a phosphor screen Incidentally, the phosphor layers of the respective colors can also be formed by a spray method or a printing method.

Next, a resin film having smoothness is formed on the phosphor screen by a transfer system using a transfer film described below.

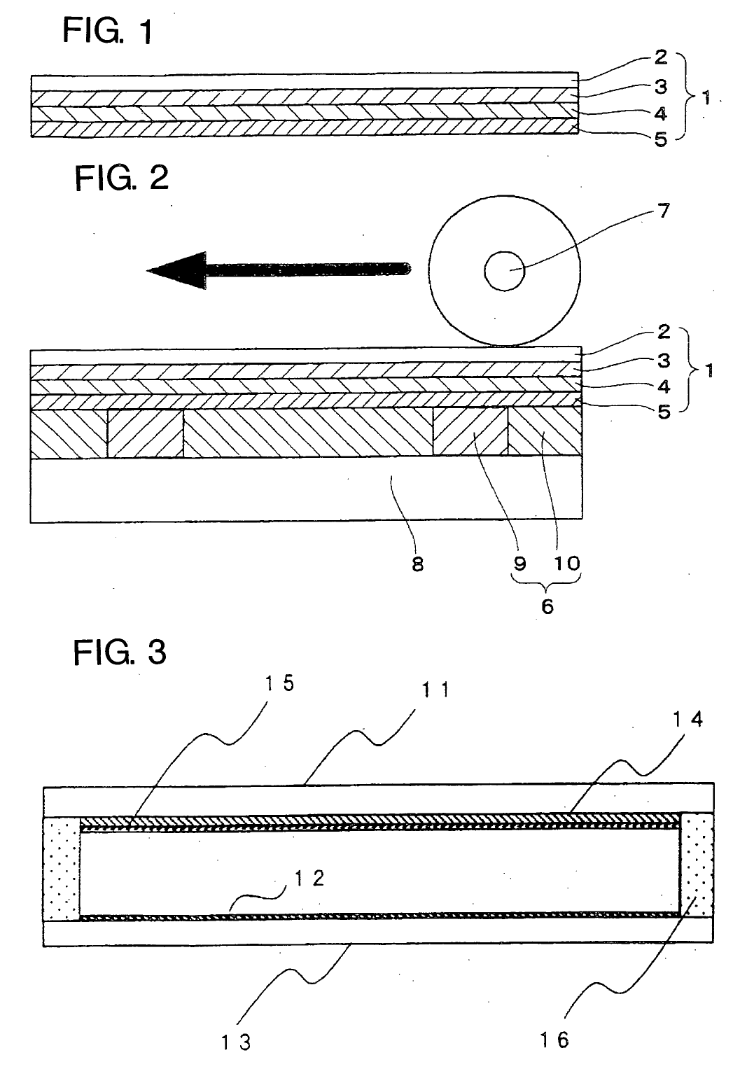

A structure of the transfer film is shown in FIG. 1. As shown in this drawing, a transfer film 1 has a structure in which on a base film 2 made of a polyester resin or the like there are sequentially deposited a release agent layer 3, a smooth resin film 4 and an adhesive agent layer 5.

Here, it is desirable that a film thickness of the base film 2 is 5 to 50 μm in order to effectively perform heating and pressing by a roller (transfer roller) in a transfer process described later. As the release agent there are cited a cellulose acetate, a wax, a fatty acid, a fatty acid amid, a fatty acid ester, a rosin, an acrylic resin, a silicone, a fluoropolymer, or the like, and the release agent is properly selected therefrom and used in response to a removability between the base film 2 and the smooth resin film 4 or the like.

It is desirable that the smooth resin film 4 formed on the release agent layer 3 is based on a thermosetting resin, a thermoplastic resin, a light-curing resin, or the like, and it is desirable that the smooth resin film 4 further contains a softening agent. As the softening agent, there are exemplified a phosphoric ester, an aliphatic monobasic acid ester, an aliphatic dibasic acid ester a dihydric alcohol ester, an oxyacid ester, a butyl oleate, a dibutyl adipate, a paraffin chloride, a toluene sulfonethylamide, a toluene sulfonmethylamide, an aminobenzene sulfonamide compound, a methyl abietate, a dinonylnaphthalene an acetyl tributyl citrate, an aminotoluene sulfonamide compound, an N-butyl benzene sulfonamide, and so on.

More specifically, the smooth resin film 4 is used which has as a main component one kind or more of resins selected from an acrylic resin, a melamine resin, an urea resin, an acryl-melamine copolymer resin, a melamine-urea copolymer resin, a polyurethane resin, a polyester resin, an epoxy resin, an alkyd resin, a polyamide resin, celluloses, a vinyl-based resin and the like, and one kind or more of softening agents selected from the above-described group is contained. Incidentally, it is desirable that a content ratio of the softening agent is 1 to 30 weight % for an entire material constituting the resin film. When the content ratio of the softening agent exceeds 30 weight %, a transferability deteriorates, and it is undesirable.

As the adhesive agent, there is used a vinyl acetate resin, an ethylene-vinyl acetate copolymer, a styrene-acrylic acid resin, an ethylene-vinyl acetate-acrylic acid terpolymer resin or the like.

Next, as shown in FIG. 2, the transfer film 1 having the above-described constitution is disposed in such a way that the adhesive agent layer 5 contacts a surface of a phosphor screen 6. Then, after the smooth resin film 4 is adhered by being pressed while being heated with a transfer roller 7, the base film 2 is peeled off. Incidentally, in the drawings, numeral 8 denotes a face plate (glass substrate), numeral 9 denotes a light absorption layer, and numeral 10 denotes a phosphor layer, respectively.

As the transfer roller 7, a rubber roller having a covering layer of a natural rubber or a silicone rubber on a metal core material, for example, is used It is desirable that this transfer roller 7 is heated such that a temperature of a surface of the rubber layer being a pressing portion becomes 70 to 240° C. and moved on a base film 2 of the transfer film 1 in a velocity of 1-20 m/min while pressing by a pressing force of 1-10 kgf/cm².

The above-described conditions for the surface temperature and the pressing velocity of the transfer roller 7 are the necessary and sufficient conditions for the smooth resin film 4 of the transfer film 1 to be transferred onto the phosphor screen 6, and hence, if out of these ranges, the adhesiveness between the phosphor layer 10 or the like and the smooth resin film 4 is insufficient and a transfer failure or a crack after baking may occur.

In other words if the surface temperature of the transfer roller 7 is too high or the pressing velocity is too slow, the base film 2 is excessively heated to cause softening or melting, and the resin film with surface smoothness is not transferred/formed. Thus, the crack or the like occurs in the metal film formed thereon, which is undesirable. Meanwhile, if the surface temperature of the transfer roller 7 is too low or the pressing velocity is too fast, heating of the adhesive agent is insufficient and adhering of the smooth resin film 4 becomes insufficient consequently causing a transfer failure such that some parts are not transferred.

It should be noted that, in such pressing by the transfer roller 7 in addition to a mode in which the transfer roller 7 is moved while the face plate side being a portion to be pressed is fixed, a mode can be adopted in which the face plate side is moved/traveled while a position of the transfer roller 7 is fixed. Therefore, the pressing velocity by the transfer roller 7 means a relative moving velocity of the transfer roller 7 to the face plate side.

After the smooth resin film 4 is transferred onto the phosphor screen 6 of the face plate 8 in this way, the transferred resin film can be pressed while being heated by a press roller. By performing such pressing, the resin film can closely contact the phosphor screen face, enabling to enhance smoothness of the resin film surface.

As the press roller, a rubber roller having a covering layer of a natural rubber or a silicone rubber on a metal core material similarly to the transfer roller, for example, is used. It is desirable that this press roller is heated such that a temperature of a surface of the rubber layer being a pressing portion becomes 70 to 250° C. and is moved on the smooth resin film 4 in a velocity of 1-20 m/min while being pressed by a pressing force of 1-10 kgf/cm².

Incidentally, also in pressing by the press roller, in addition to a mode in which the press roller is moved while the face plate side is fixed, a mode can be adopted in which the face plate side is moved/traveled while the press roller is fixed.

After pressing is performed in this way, a metal film is formed on the smooth resin film. It is preferable that a film thickness of the metal film is 40 nm to 150 nm in view of a metal back effect. As for a method for forming the metal film, any method can be used as long as it is a general dry method for forming a metal thin film such as a vacuum deposition method and a spattering method.

The face plate as a whole is heated/baked to approximately 450° C. so that an organic material is decomposed and removed, and a metal back layer is formed. In this way, a smooth and flat metal back layer without a projection/depression, a crack or a crease is formed, and a metal back-attached phosphor screen excellent in adhesiveness between the phosphor layer and the metal back layer can be obtained.

Next, an FED having the metal back-attached phosphor screen formed in this way as an anode electrode will be described based on FIG. 3.

In this FED, it is constructed such that a face plate 11 having the metal back-attached phosphor screen formed in the above-described embodiment and a rear plate 13 having electron emission elements 12 arranged in a matrix are disposed opposite to each other with a narrow space of about 1 mm to several mm, and that a high voltage of 5 to 15 kV is applied between the face plate 11 and the rear plate 13. As for numerals in the drawing, 14 denotes a phosphor screen having a light absorption layer and a phosphor layer, and 15 denotes a metal back layer. The numeral 16 denotes a supporting frame (side wall).

The space between the face plate 11 and the rear plate 13 is extremely narrow and an electric discharge (dielectric breakdown) easily occurs therebetween, but in this FED, the smooth and flat metal back layer 15 without the projection/depression, the crack, or the crease is provided and the adhesiveness between the metal back layer 15 and the phosphor screen 14 is high, so that the electric discharge is restrained to drastically improve a withstand voltage characteristic Additionally, since there is no crack or pinhole in the metal back layer 15 and the light transmittance is low and the reflectivity is high, display of a high luminance and a high reliability can be realized.

### EXAMPLE

Next, a concrete practical example in which the present invention is applied to an FED will be described.

### EXAMPLE

First, after light absorption layers made of a black pigment in stripes were formed on an inner surface of a face plate by a photolithography method, a slurry containing phosphors of respective colors of ZnS-base, Y₂O₃-base, or Y₂O₂S-base or the like was applied thereon and dried, patterning being performed using the photolithography method. Phosphor layers of three colors of red (R), green (G), and blue (B) were formed between light shielding portions of the light absorption layers in a such a way as to be adjacent to each other in stripes to produce a phosphor screen.

Next, a transfer film described below was formed. Are lease agent layer of 0.5 μm in thickness was formed on a base film made of a polyester resin of 20 μm in film thickness, and thereon applied by a gravure coater and dried to form a smooth resin film of 0.3 μm in thickness was a resin composition made of 25 weight parts (hereinafter, referred to as just “part”) of methyl isobutyl ketone, 25 parts of methyl ethyl ketone, 6 parts of denatured alcohol, 10 parts of toluene, 10 parts of butyl acetate, 10 parts of ethyl acetate, 5 parts of melamine resin, 5 parts of urea resin, 1 part of cellulose derivative, 1 part of rosin-based resin, 1 part of dimethylsiloxane, 0.5 parts of phosphoric acid, and 0.5 parts of p-toluenesulfonic aid.

Next, on this smooth resin film, a resin composition made of 90 parts of toluene and 10 parts of vinyl acetate was applied by the gravure coater and dried to for an adhesive agent layer of 10 μm in thickness and the transfer film was brought to completion.

After this transfer film was disposed on the phosphor screen so that the adhesive agent layer contacted the phosphor layer, the transfer film was press-fixed by pressing with a pressure of 500 kgf/cm² by a rubber roller (transfer roller) which had a rubber covering layer with 90 degree hardness and whose surface temperature was heated to be 200° C. while moving the transfer roller in a velocity of 5.4 m/min, and then the base film was peeled off. In this way, the smooth resin film was transferred onto the phosphor screen of the face plate.

Subsequently, the transferred smooth resin film was further pressed by a rubber roller (press roller) of 80 degree hardness and of 180° C. surface temperature in a velocity of 1.0 m/min and in a pressure of 800 kgf/cm² so that the smooth resin film was adhered onto the phosphor screen.

Next, after an Al film of 50 nm in thickness was formed on the smooth resin film by a vacuum deposition method, the face plate on which the Al film was formed in this way was heated and baked at 450° C. so that an organic material was decomposed and removed. In this way, the metal back layer without a defect such as a crack or a pinhole was formed on the phosphor screen.

Meanwhile, as a comparative example, a metal back layer was formed by a conventional transfer system in which a transfer film having a metal deposited film was used. A transfer film in which a release agent layer, Al deposited film and an adhesive agent layer were sequentially formed on a base film made of a polyester resin was used, and after this transfer film was disposed on a phosphor screen, the transfer film was heated and pressed by a transfer roller to transfer the Al deposited film, as in the practical example. Subsequently, a metal back layer was formed through a pressing process by a press roller and a heating and baking process.

Next, FEDs were produced in the well-known way using the face plates having the metal back-attached phosphor screens obtained in the practical example and the comparative example as stated above. First, an electron generating source having numerous surface-conductive electron emission elements formed on substrate in a matrix was fixed on glass substrates to produce a rear plate. Next, this rear plate and the above-described face plate were disposed to be opposed via supporting frames and spacers and sealed by flit glasses Subsequently, necessary processings such as sealing and exhausting was performed and 10-inch color FED was completed.

Next, for these FEDs, 3000 hour driving tests were performed at an electron beam acceleration voltage of 10 kV. As a result, in the FED having the metal back-attached phosphor screen obtained in the comparative example, three times of electric discharge phenomena occurred during 3000 hours, while in the FED having the metal back-attached phosphor screen obtained in the practical example, no electric discharge phenomenon occurred during 3000 hours. Additionally, a luminance was also improved by 5% compared to the FED of the comparative example.

### INDUSTRIAL APPLICATION

According to the present invention, a metal back layer which is smooth and which has a high adhesiveness with a phosphor layer can be formed, and a metal back-attached phosphor screen having a high critical holding voltage can be obtained. Meanwhile, the metal back layer does not have a pinhole or a crack and has a low light transmittance state, so that light emission brightness is improved. Therefore, by providing such a metal back-attached phosphor screen, an image display device with an excellent withstand voltage characteristic and a high luminance can be realized.

1. A method for forming a metal back-attached phosphor screen, comprising:
forming a phosphor layer on an inner surface of a face plate; disposing a transfer film in which at least a release agent layer, a smooth resin film and an adhesive agent layer are formed on a base film onto the phosphor layer so that the resin film contacts the phosphor layer with the adhesive agent layer intervened therebetween, pressing the transfer film while applying heat by a transfer roller to bond the transfer film, and subsequently peeling off the base film, to thereby transfer the resin film;
forming a metal film on the resin film transferred onto the phosphor layer; and
heating the face plate in which the metal film is formed.

2. The method for forming the metal back-attached phosphor screen of claim 1, further comprising pressing the resin film transferred onto the phosphor layer while applying heat by a press roller.

3. The method for forming the metal back-attached phosphor screen of claim 1, wherein the resin film comprises one or more of resins selected from the group consisting essentially of an acrylic resin, a melamine resin, an urea resin, an acryl-melamine copolymer resin, a melamine-urea copolymer resin, a polyurethane resin, a polyester resin, an epoxy resin, an alkyd resin, a polyamide resin, cellulose-based resin, and a vinyl-based resin.

4. The method for forming the metal back-attached phosphor screen of claim 1, wherein the resin film comprises a resin as a main component and comprises one or more of softening agents selected from the group consisting essentially of a phosphoric ester, an aliphatic monobasic acid ester, an aliphatic dibasic acid ester, a dihydric alcohol ester, an oxyacid ester, a butyl oleate, a dibutyl adipate, a paraffin chloride, a toluene sulfonethylamide, a toluene sulfonmethylamide, an aminobenzene sulfonamide, a methyl abietate, a dinonylnaphthalene, an acetyl tributyl citrate, an aminotoluene sulfonamide, and an N-butyl benzene sulfonamide.

5. The method for forming the metal back-attached phosphor screen of claim 4, wherein the softening agent is comprised in a ratio of 1 to 30 weight % of the entire materials constituting the resin film.

6. The method for forming the metal back-attached phosphor screen of claim 1, wherein the adhesive agent comprises as a main component one or more of resins selected from the group consisting essentially of a vinyl acetate resin, an ethylene-vinyl acetate copolymer, a styrene-acrylic acid resin, an ethylene-vinyl acetate-acrylic acid terpolymer resin, a vinyl chloride-vinyl acetate copolymer resin, a polybutene resin, and a polyamide resin.
